(19) United States
(12) Patent Application Publication
(10) Pub. No.: US 2012/0320620 A1
(43) Pub. Date: Dec. 20, 2012

(54) SYSTEM FOR DISPLAYING IMAGES ON THE BACK OF A HITCH

(76) Inventor: Roger Keith Bosarge, Jacksonville, FL (US)

(21) Appl. No.: 13/490,448

(22) Filed: Jun. 6, 2012

Related U.S. Application Data
(60) Provisional application No. 61/571,012, filed on Jun. 20, 2011.

(51) Int. Cl. B60Q 1/26

(52) U.S. Cl. 362/546

(57) ABSTRACT

An illuminated, image adjustable hitch cover allows a user to provide various images inside the hitch cover without the need to purchase an entire new hitch cover. The hitch cover can include an image, which can be an image printed by the user, such as a picture or text, that is inserted between two panes of clear material, such as clear plastic. The hitch cover may be illuminated along with the user's lights and may brighten or come on when the user pressed their brakes, providing not only a desired aesthetic result, but also a safety function.

### CROSS-REFERENCE TO RELATED APPLICATIONS

This application claims the benefit of priority of U.S. provisional patent application No. 61/571,012, filed Jun. 6, 2011, the contents of which are herein incorporated by reference.

### BACKGROUND OF THE INVENTION

The present invention relates to vehicle hitch accessories and, more particularly, to a system for displaying images, such as images off the internet, on the back of an illuminated hitch of a vehicle.

Currently, people have to buy expensive etched lenses to change images on their display. These pre-manufactured images are the only ones available to the consumer to purchase. The selection available to the consumer may be inadequate and not include a particular design of interest.

As can be seen, there is a need for a system for displaying images on the back of a hitch that allows a user to select their images from any number of printable designs.

### SUMMARY OF THE INVENTION

In one aspect of the present invention, a hitch cover comprises a hitch tube adapted to fit into a receiver hitch of a vehicle; a light box connected at an end of the hitch tube; a light bulb disposed inside the light box; a backing pane disposed adjacent to the light bulb, the backing pane operable to support a printed image thereupon; and a cover operable to protect the printed image supported on the backing pane.

In another aspect of the present invention, a hitch cover comprises a hitch tube adapted to fit into a receiver hitch of a vehicle; a light box connected at an end of the hitch tube; a light bulb disposed inside the light box; a cable electrically connected to the light bulb on a first end thereof and having a connector on a second end thereof; a backing pane disposed adjacent to the light bulb, the backing pane operable to support a printed image thereupon; a cover operable to protect the printed image supported on the backing pane; and a cushion disposed about the light box, the cushion adapted to seal a connection between the light box and the hitch tube.

These and other features, aspects and advantages of the present invention will become better understood with reference to the following drawings, description and claims.

### BRIEF DESCRIPTION OF THE DRAWINGS

FIG. 1 is a perspective view of an illuminated, image adjustable hitch cover according to an exemplary embodiment of the present invention;

FIG. 2 is a perspective view of the illuminated, image adjustable hitch cover of FIG. 1;

FIG. 3 is an exploded perspective view of the illuminated, image adjustable hitch cover of FIG. 1;

FIG. 4 is a cross-sectional view taken along line 4-4 of FIG. 2;

FIG. 5 is a perspective view of an illuminated, image adjustable hitch cover, showing insertion of a user printed image according to an alternate embodiment of the present invention;

FIG. 6 is a perspective view of an illuminated, image adjustable hitch cover, showing a user printed image inserted therein according to another alternate embodiment of the present invention, with a hinged transparent step closed; and

FIG. 7 is a perspective view of the illuminated, image adjustable hitch cover of FIG. 6, showing the hinged transparent step open to allow a user to step upon as a step.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an illuminated, image adjustable hitch cover that allows a user to provide various images inside the hitch cover without the need to purchase an entire new hitch cover. The hitch cover can include an image, which can be an image printed by the user, such as a picture or text, that is inserted between two panes of clear material, such as clear plastic. The hitch cover may be illuminated along with the user's lights and may brighten or come on when the user pressed their brakes, providing not only a desired aesthetic result, but also a safety function.

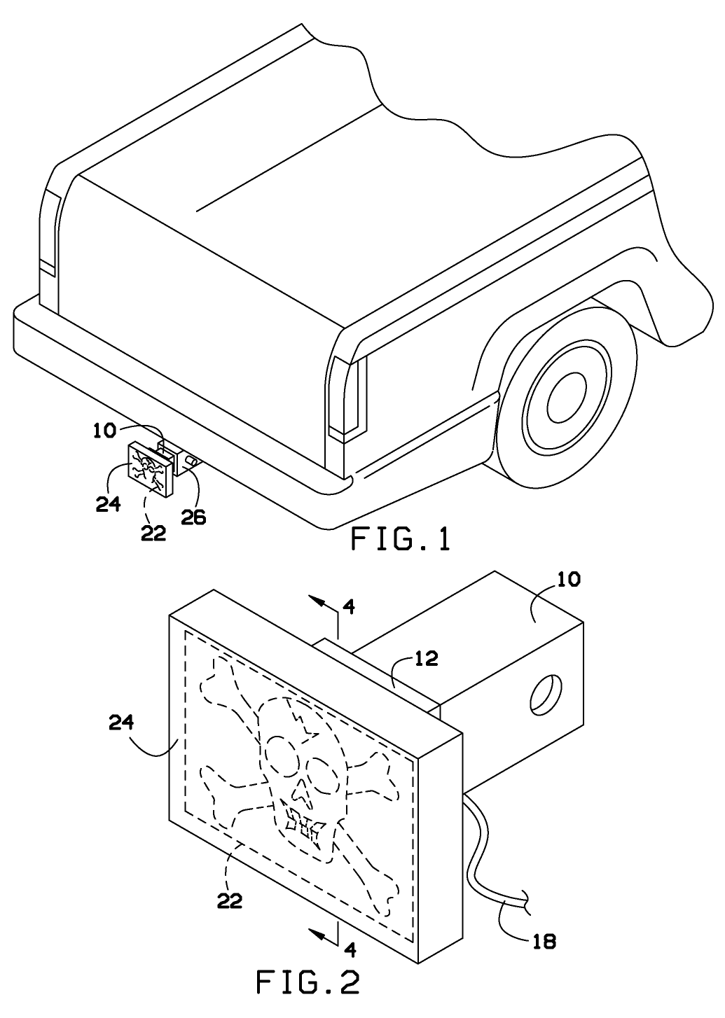

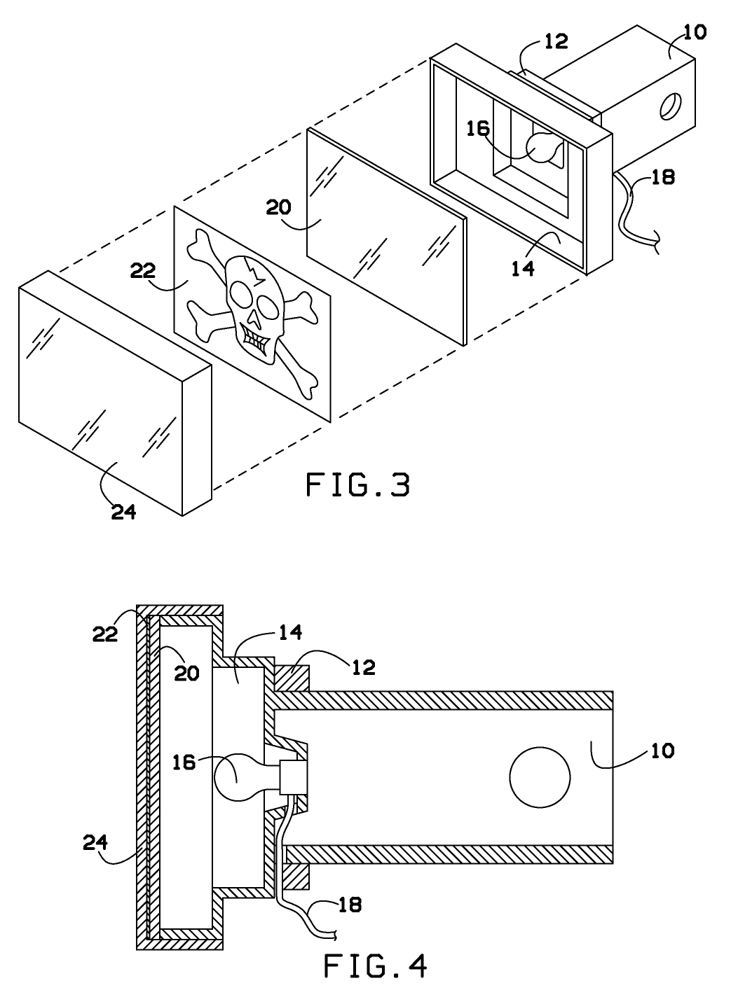

Referring now to FIGS. 1 through 4, a hitch cover can include a hitch tube 10 adapted to fit into a receiver hitch 26 of a vehicle. The hitch tube 10 can include a hole horizontally therethrough to align with a standard receiver hitch hole. A light box 14 may be connected to the hitch tube 10. In some embodiments, a cushion 12 may be provided between the light box 14 and the hitch tube 10. The cushion 12 may provide some resiliency to for the light box 14 and may also help seal the light box 14 to the hitch tube 10. In some embodiments, the light box 14 may be formed integrally with the hitch tube 10.

A light bulb 16 may be disposed inside the light box 14. A power cable 18 may electrically connect to the light bulb 16. The power cable 18 may be adapted to fit into a standard 7-pin hitch power socket, for example. Alternately, the power cable 18 may fit into a standard 4-pin hitch power socket. The light bulb 16 may be wired to illuminate when the user operates their head/tail lights. The light bulb 16 may further illuminate, typically with an additional filament disposed therewithin, when the brakes are depressed, resulting in a brighter illumination when the brakes are depressed. In some embodiments, two light bulbs may be disposed inside the light box 14, one illuminated with the head/tail lights, and the other illuminated with the brake activation.

A clear backing pane 20 may be disposed inside or against the light box 16, adjacent the light bulb 16. In some embodiments, as shown in FIG. 4, the light box 16 may be stepped such that the clear backing pane 20 may press against an outside periphery of the light box 16.

A printed image 22 may be disposed against the clear backing pane 20 and an outer lens 24 may cover the printed image 22. The outer lens 24 may be disposed such that side walls of the outer lens 24 may fit over an outside portion of the light box 14. In some embodiments, the outer lens 24 may frictionally fit against the light box 14. In other embodiments, the outer lens 24 may include on or more resilient protrusions that clip the outer lens 24 onto the light box 14. Other means for the outer lens 24 to removably connect to the light box 14 are included within the scope of the present invention. In some embodiments, the outer lens 24 can attach magnetically together with the clear backing pane 20.

Referring to FIG. 5, in some embodiments, a slide in slot 28 may be provided between the outer lens 24 and the clear backing pane 20. The printed image 22 may fit into the slot 28. A thumb notch 30 may be provided along an open end of the slot 20 to provide a user with a means to easily remove and change the printed image 22. In this embodiment, the outer lens 24 may be connected permanently to the light box 14, since removal of the outer lens 24 from the light box 14 is not needed, as is done with the embodiment of FIGS. 1 through 4.

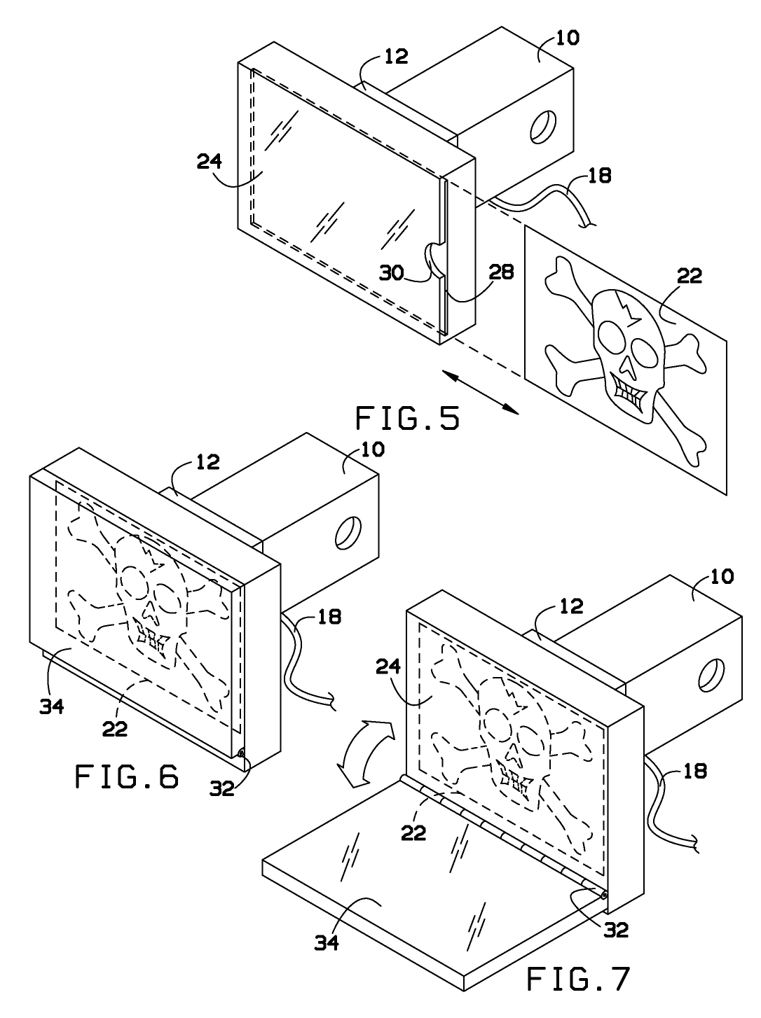

Referring to FIGS. 6 and 7, in some embodiments, a hinged transparent step 34 may be disposed with a hinge 32 onto the hitch cover. The hinged transparent step 34 may move between a closed position (FIG. 6) and an open position (FIG. 7). The transparent step 34 may provide a user with a step to, for example, provide access to cargo stored in the vehicle. The transparent step 34 can be stored in the closed position without affecting the view of the printed image 22 within the hitch cover.

It should be understood, of course, that the foregoing relates to exemplary embodiments of the invention and that modifications may be made without departing from the spirit and scope of the invention as set forth in the following claims.

What is claimed is:

1. A hitch cover comprising:
a hitch tube adapted to fit into a receiver hitch of a vehicle;
a light box connected at an end of the hitch tube;
a light bulb disposed inside the light box;
a backing pane disposed adjacent to the light bulb, the backing pane operable to support a printed image thereupon; and
a cover operable to protect the printed image supported on the backing pane.

2. The hitch cover of claim 1, further comprising a cushion disposed about the light box, the cushion adapted to seal a connection between the light box and the hitch tube.

3. The hitch cover of claim 1, where the cover is adapted to removably fit about at least a portion of an outer periphery of the light box.

4. The hitch cover of claim 1, wherein a slide in slot is formed between the backing pane and the cover.

5. The hitch cover of claim 4, further comprising a thumb notch adapted to provide access to a portion of the printed image disposed in the slide in slot.

6. The hitch cover of claim 1, further comprising a hinged transparent step adapted to fold down away from the printed image to provide a step for a user.

7. The hitch cover of claim 1, further comprising a cable electrically connected to the light bulb on a first end thereof and having a connector on a second end thereof.

8. A hitch cover comprising:
a hitch tube adapted to fit into a receiver hitch of a vehicle;
a light box connected at an end of the hitch tube;
a light bulb disposed inside the light box;
a cable electrically connected to the light bulb on a first end thereof and having a connector on a second end thereof;
a backing pane disposed adjacent to the light bulb, the backing pane operable to support a printed image thereupon;
a cover operable to protect the printed image supported on the backing pane; and
a cushion disposed about the light box, the cushion adapted to seal a connection between the light box and the hitch tube.

9. The hitch cover of claim 8, wherein the light bulb is a multi-filament bulb adapted to illuminate when head/tail lights are illuminated and further illuminate when a brake is engaged in the vehicle.

10. The hitch cover of claim 9, further comprising a hinged transparent step adapted to fold down away from the printed image to provide a step for a user.
